(19) United States
(12) Patent Application Publication
(10) Pub. No.: US 2025/0077141 A1
(43) Pub. Date: Mar. 6, 2025

(54) IMAGE FORMING APPARATUS, CONTROL METHOD FOR IMAGE FORMING APPARATUS, AND STORAGE MEDIUM

(71) Applicant: CANON KABUSHIKI KAISHA, Tokyo (JP)

(72) Inventor: KEISUKE AIZONO, Chiba (JP)

(21) Appl. No.: 18/815,617

(22) Filed: Aug. 26, 2024

(30) Foreign Application Priority Data
Sep. 1, 2023 (JP) 2023-142175

(51) Int. Cl. G06F 3/12; G06F 21/10

(52) U.S. Cl. CPC G06F 3/1238; G06F 3/1215; G06F 3/1222; G06F 21/105

(57) ABSTRACT

An image forming apparatus includes an execution unit that executes a function of the image forming apparatus, an acceptance unit that accepts an operation, and a control unit that executes control to permit the execution of the function with a license granting permission to execute the function and to prohibit the execution of the function when the license is not granted. The control unit exceptionally permits the execution of the function based on acceptance of a predetermined operation by the acceptance unit even when the license is not granted and prohibits the execution of the function based on a satisfaction of a condition with the execution of the function exceptionally permitted.

### BACKGROUND

### Field

The present disclosure relates to an image forming apparatus, a control method for the image forming apparatus, and a storage medium.

Description of the Related Art

Japanese Patent Application Laid-Open No. 2021-5005 discusses a technique for enabling an image forming apparatus to execute printing at a printing speed specified by a license granted to the image forming apparatus after factory shipment.

However, with the technique discussed in Japanese Patent Application Laid-Open No. 2021-5005, functions permitted by the license are only used when the license is granted to the image forming apparatus. Thus, there is a possibility that the image forming apparatus does not operate as efficiently in an actual situation after factory shipment.

### SUMMARY OF THE INVENTION

In light of the above, the present disclosure is directed to a technique that enables an image forming apparatus to efficiently operate in an actual situation following factory shipment.

According to an aspect of the present disclosure, an image forming apparatus includes an execution unit configured to execute a function of the image forming apparatus, an acceptance unit configured to accept an operation, and a control unit configured to execute control to permit the execution of the function with a license granting permission to execute the function and to prohibit the execution of the function when with the license is not granted. The control unit exceptionally permits the execution of the function based on acceptance of a predetermined operation by the acceptance unit even when the license is not granted, and prohibits the execution of the function based on a satisfaction of a condition with the execution of the function exceptionally permitted.

Further features of the present disclosure will become apparent from the following description of exemplary embodiments with reference to the attached drawings.

### BRIEF DESCRIPTION OF THE DRAWINGS

FIG. 1 is a block diagram illustrating the configuration of an image forming apparatus.

FIG. 2 is a table illustrating setting information.

FIGS. 3A and 3B are a flowchart illustrating processing executed when the image forming apparatus is activated.

FIGS. 4A-A and 4A-B are diagrams illustrating a home screen and a copy setting screen, respectively.

FIGS. 4B-A to 4B-C are diagrams illustrating job limitation screens.

FIG. 5 is a flowchart illustrating license acceptance processing.

FIGS. 6A to 6C are diagrams illustrating screens displayed when license acceptance processing is being executed.

FIG. 7 is a flowchart illustrating processing for limiting a job.

FIG. 8 is a flowchart illustrating processing for placing limitations on a job based on elapsed time.

### DESCRIPTION OF THE EMBODIMENTS

Hereinafter, an exemplary embodiment of the present disclosure will be described with reference to the appended drawings.

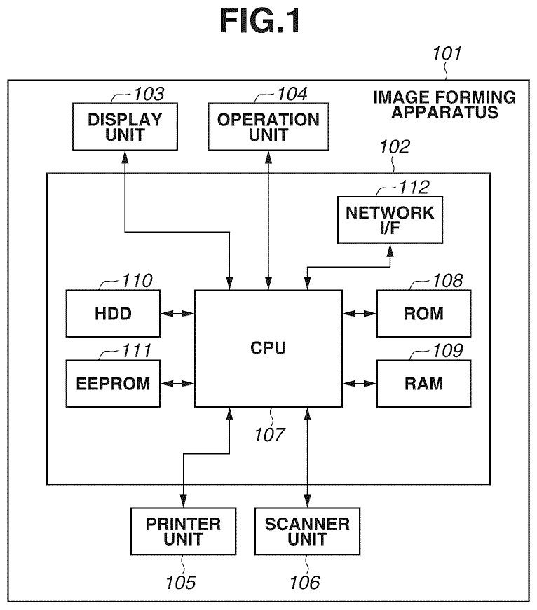

FIG. 1 is a block diagram illustrating an example of the configuration of an image forming apparatus 101.

In FIG. 1, the image forming apparatus 101 includes a controller unit 102, a display unit 103, an operation unit 104, a printer unit 105, and a scanner unit 106.

The display unit 103 displays contents of user operations and internal information about the image forming apparatus 101.

For example, the display unit 103 includes a light emitting element (e.g., light emitting diode (LED)) and a computer display (e.g., liquid crystal display).

The operation unit 104 accepts operations from a user. For example, the operation unit 104 includes a plurality of operation buttons. The operation unit 104 and the display unit 103 can integrally function as a touch display. In the present exemplary embodiment, when a predetermined operation is performed on an operation button included in the operation unit 104, processing is started in a temporary activation mode described below.

For example, the controller unit 102 includes a central processing unit (CPU) 107, a read only memory (ROM) 108, a random access memory (RAM) 109, a hard disk drive (HDD) 110, an electrically erasable programmable read only memory (EEPROM) 111, and a network interface (I/F) 112. The CPU 107 is an execution medium for control programs in the image forming apparatus 101. The CPU 107 controls the operations of the devices connected to the controller unit 102 via an interface or a memory, such as a storage medium. The image forming apparatus 101 can also include another processor (e.g., graphics processing unit (GPU)) in addition to or in place of the CPU 107. Further, the image forming apparatus 101 can include one or a plurality of pieces of dedicated hardware different from the CPU 107. At least part of the processing executed by the CPU 107 can be executed by dedicated hardware. An application specific integrated circuit (ASIC), a field programmable gate array (FPGA), and a digital signal processor (DSP) can be given as the examples of dedicated hardware.

The ROM 108 is a read only memory. A boot program used to activate a system is stored in the ROM 108. The RAM 109 is a volatile memory. The RAM 109 serves as a work memory used to execute a control program. The HDD 110 is a storage medium, such as a magnetic disk. Control programs and image data are stored in the HDD 110. The EEPROM 111 is a non-volatile memory. Setting values used to execute control programs are stored in the EEPROM 111.

The controller unit 102 instructs the printer unit 105 to execute printing image data transmitted from the controller unit 102 on sheets. In response to a read instruction from the controller unit 102, the scanner unit 106 optically reads information printed on a sheet and transmits image data based on the read information to the controller unit 102.

Herein, an outline of the present exemplary embodiment will be described.

The image forming apparatus 101 according to the present exemplary embodiment executes control based on a license for permitting use of functions provided by the image forming apparatus 101. In the present exemplary embodiment, a license which permits execution of jobs including print jobs will be described. Further, in the present exemplary embodiment, a license which specifies a printing speed will be described. As described below, in the present exemplary embodiment, the printing speed of the image forming apparatus 101 is set to zero (0) at the time of factory shipment, so that the default value of the printing speed is zero (0). This prevents the image forming apparatus 101 from executing printing unless the license is granted thereto. The license granted to the image forming apparatus 101 permits the image forming apparatus 101 to execute printing on sheets at printing speeds specified by the license. In addition, granting the license refers to registering the authority to execute printing at printing speeds specified by the license on the image forming apparatus 101, the license of which is, for example, granted to the image forming apparatus 101 when a user inputs the correct license key by operating the operation unit 104. The validity of the license key can be determined by the image forming apparatus 101 or an external device.

Changing the printing speed after the factory shipment through the grant of a license allows the license to be provided to the user as a commercial product and imbalance in stock in the market to also be reduced. Further, the license is granted to the image forming apparatus with the printing function disabled at the time of factory shipment, allowing printing to be executed.

On the other hand, the image forming apparatus after the factory shipment has a component used in itself replaced in some cases. In such a case, the image forming apparatus may be checked for proper operations without any problem after the component is replaced. At this time, for example, it is conceivable that an operation mode which enables the image forming apparatus whose printing function is disabled after the factory shipment to exceptionally (temporarily) execute printing without the license granted may be provided to the image forming apparatus. This improves the convenience of the vendor. In addition, examples of vendors include manufacturers, distributors, and maintenance agencies. Further, an example of the mode is a temporary activation mode described below.

However, if a user finds out a method for executing processing in the above-described mode, the user can operate the image forming apparatus, such as printing, without purchasing the license. Consequently, an operation that exceptionally executes printing by only an operator of the vendor without a license (in other words, not a user, which the vendor does not wish to grant the operation to), the operation of which does not square with reality, may be operated by the image forming apparatus.

In the present exemplary embodiment, an example is illustrated where the image forming apparatus 101 operates as follows.

First, according to the present exemplary embodiment, the setting and execution of any job, including a print job and a scan job, are prohibited with a license not granted to the image forming apparatus 101. Some of the jobs, not any of the jobs, (e.g., at least one of a print job and a scan job) can be prohibited. Further, any method can be used for prohibiting the setting and execution of a job. For example, an operation (e.g., icon selection) on a graphical user interface (GUI) on the image forming apparatus 101 to go to a screen for setting and instructing execution of a job can be prohibited. Further, while a screen for setting and instructing execution of a job can be displayed on the image forming apparatus 101, selecting a GUI for performing a job setting (e.g., button selection) and/or a GUI for instructing execution of the job can be disabled. Furthermore, while the selections of the GUIs can be made, the execution of a job can be prohibited. In this case, the image forming apparatus 101 can display on the display unit 103 a message indicating that no job can be executed with a license not registered. Further, the execution of a job on the image forming apparatus 101 can be prohibited while the job setting is allowed.

Further, a device setting that is not related to a job-unit setting, such as a print job setting or a scan job setting, may be or may not be prohibited in the same way as the setting and execution of a job. A device setting, such as an image adjustment and a network setting, can be given as examples of a device setting not related to a job-unit setting.

Further, in the present exemplary embodiment, the image forming apparatus 101 is exceptionally permitted to set and execute all of jobs including a print job and a scan job in the above-described mode, even if a license is not granted to the image forming apparatus 101. In addition, the execution of some jobs (e.g., at least any one of the print job and the scan job) can be permitted, instead of the execution of all of jobs. Further, any condition for exceptionally permitting setting and execution of a job can be used. The condition can be that a given operation is performed on the operation unit 104. The condition can be that that a given command is received by the image forming apparatus. The command can be transmitted from a terminal carried by an operator of the vendor, or can be transmitted from an information processing apparatus installed in a management center.

Furthermore, in the present exemplary embodiment, an example is illustrated where the execution of any job, including a print job and a scan job, is prohibited with setting and executing a job exceptionally permitted (when the image forming apparatus 101 is operating in the above-described mode). This can prevent the image forming apparatus 101 from executing an operation that does not square with reality. Some jobs (e.g., at least any one of the print job and the scan job), not any job, can be prohibited. Further, any method can be used for prohibiting setting and executing a job. For example, an operation (e.g., icon selection) on a graphical user interface (GUI) on the image forming apparatus 101 to go to a screen for setting and instructing execution of a job can be prohibited. Further, while a screen for setting and instructing execution of a job can be displayed on the image forming apparatus 101, selecting a GUI for performing a job setting (e.g., button selection) and/or a GUI for instructing execution of the job can be disabled. Furthermore, while the selections of the GUIs can be made, the execution of a job can be prohibited. In this case, the image forming apparatus 101 can display on the display unit 103 a message indicating that no job can be executed with a license not registered. Further, the execution of a job on the image forming apparatus 101 can be prohibited while the job setting is allowed.

Further, a device setting that is not related to a job-unit setting, such as a print job setting or a scan job setting, may be or may not be prohibited in the same way as the setting and execution of a job. A device setting, such as an image adjustment and a network setting, can be given as examples of a device setting not related to a job-unit setting.

Any condition can be used for prohibiting setting and execution of a job when the setting and execution of a job is exceptionally permitted (when the image forming apparatus 101 is operating in the above-described mode). The condition can be that a given operation is performed on the operation unit 104. For example, an operator of the vendor can execute the above-described given operation after checking operation. Further, the condition can be determined based on the operation of the image forming apparatus 101 in the above-described mode. The operation can include at least one of number counting executed by the image forming apparatus 101 based on the execution of a job in the above-described mode and time counting of a period when the image forming apparatus 101 is operating in the above-described mode. Number counting executed based on the execution of a job can be performed on the number of sheets printed or the number of sheets scanned. In the present exemplary embodiment, these conditions are described as examples of suspension conditions. Further, in one embodiment, the above-described counted number value and the counted time value are accumulated when the above-described mode is repeated at time intervals. However, the counted number value and the counted time value can be reset when the above-described mode is ended.

The prohibition of the setting and execution of a job can be removed if a license is granted to the image forming apparatus 101 after the setting and execution of a job is prohibited with the setting and execution of a job exceptionally permitted as above mentioned. In this case, granting the license to the image forming apparatus 101 is an example of a predetermined suspension release condition. In consideration of a case where time taken to replace a component is prolonged or more sheets printed for checking operation, the prohibition of the setting and execution of a job can be removed if the image forming apparatus 101 is rebooted. In this case, rebooting the image forming apparatus 101 is an example of a predetermined suspension release condition. Further, even if a license is not granted to the image forming apparatus 101, the prohibition of the setting and execution of a job can be removed when a predetermined operation is performed on the operation unit 104. In this case, performing the predetermined operation on the operation unit 104 is an example of a predetermined suspension release condition.

Furthermore, in the present exemplary embodiment, a case is illustrated where the setting and execution of a job is prohibited while the power to set and execute a job is supplied to the image forming apparatus 101 (the power supply source is turned on). However, the present disclosure is not limited thereto. For example, the setting and execution of a job can be prohibited after the image forming apparatus 101 is brought into a sleep state. In this case, a condition for clearing the sleep state of the image forming apparatus 101 can be set to the image forming apparatus 101. The condition can be that a predetermined operation is performed on the operation unit 104. Further, the condition can be that a predetermined command is received by the image forming apparatus 101.

A specific example will now be described of a method for executing control based on the above-described license.

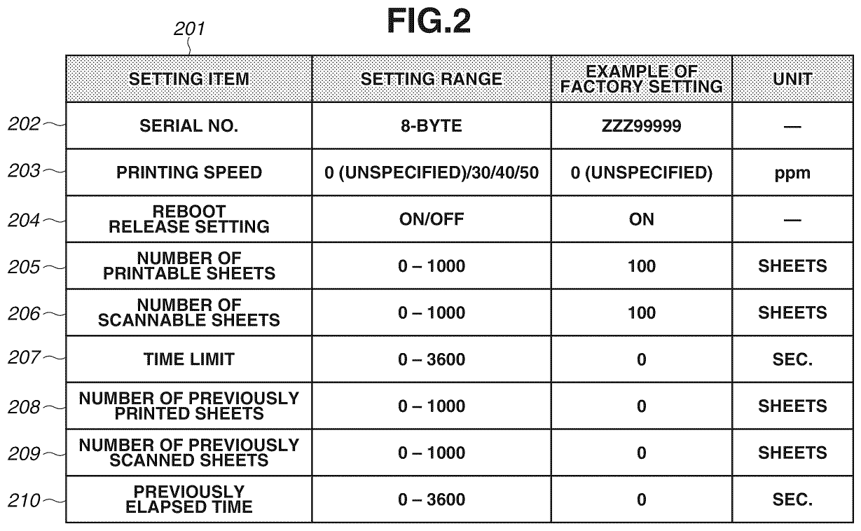

FIG. 2 is a table illustrating an example of setting information. The setting information illustrated in FIG. 2 is used when the image forming apparatus 101 executes control based on the license. For example, the setting information illustrated in FIG. 2 is stored in the EEPROM 111. In FIG. 2, a setting item 201 includes items, such as a serial No. 202, a printing speed 203, a reboot release setting 204, the number of printable sheets 205, the number of scannable sheets 206, a time limit 207, the number of previously printed sheets 208, the number of previously scanned sheets 209, and a previously elapsed time 210. In FIG. 2, an example is illustrated of the setting item 201 to describe the present exemplary embodiment. However, the setting item 201 is not limited to the contents illustrated in FIG. 2. In FIG. 2, a setting range describes a range which can be set as information about each setting item or an alternative of the information which can be set as information about each setting item. An example of factory-setting illustrates information about each setting item at factory shipment.

The serial No. 202 is a number uniquely identifying the image forming apparatus 101. The serial No. 202 is used to determine the appropriateness of a license for determining a printing speed. The serial No. 202 is set before the image forming apparatus 101 is factory-shipped. As a serial No. 202 of the image forming apparatus, a number which is not the serial Nos. of the other image forming apparatuses is assigned to the image forming apparatus 101.

The printing speed 203 is a value of a page-per-minute (ppm) notified to the printer unit 105 when the image forming apparatus 101 is activated. In the present exemplary embodiment, the printer unit 105 can change the printing speed 203 to 30 ppm, 40 ppm, or 50 ppm with the same hardware configuration. Further, “0 ppm” indicates that the printing speed 203 is unspecified (see “0 (Unspecified)” in the column of the setting range in FIG. 2).

When a license is granted to the image forming apparatus 101, the printing speed 203 is rewritten to one of the printing speeds, 30 ppm, 40 ppm, and 50 ppm, specified by the license. This allows the image forming apparatus 101 to execute printing at the rewritten printing speed 203. The printing speed 203 is set to 0 ppm at the factory shipment (see “0 (Unspecified)” in the column of the example of factory-setting in FIG. 2). In this case, the printing speed 203 is rewritten from 0 ppm to a printing speed specified by the license. In addition, with a license granted to the image forming apparatus 101, another license which specifies a printing speed different from the printing speed specified by the granted license can be granted to the image forming apparatus 101. In this case, the printing speed 203 is rewritten from a printing speed (e.g., 30 ppm) specified by the granted license to a printing speed (e.g., 40 ppm) specified by the newly granted license.

In addition, for example, the printing speed can be changed by a method similar to the method described in Japanese Patent Application Laid-Open No. 2021-5005. For example, the printing speed can be changed by changing both the process speed, i.e., a speed at which the printer unit 105 forms a toner latent image, and the image time interval, i.e., a time interval at which images are formed. Further, the printing speed can be changed by changing the image time interval without changing the process speed.

The reboot release setting 204 is information about whether a temporary activation mode is ended by rebooting the image forming apparatus 101 with the setting and execution of a job prohibited after the image forming apparatus 101 is activated in the temporary activation mode.

Herein, an example will be described of the temporary activation mode. In the present exemplary embodiment, with the printing speed 203 set to 0 ppm (unspecified), in principle, the setting and execution of any job, including a print job and a scan job, are prohibited on the image forming apparatus 101 unless a license which specifies a printing speed is granted to the image forming apparatus 101. However, as described above, for example, there is a case where a component used in the image forming apparatus has to be replaced after the factory shipment. In this case, an operation in the actual printing method cannot be checked unless a license is granted to the image forming apparatus. Thus, in the present exemplary embodiment, the image forming apparatus 101 is provided with a mode which enables the image forming apparatus 101 to be activated with a temporary printing speed even if a license is not granted thereto. In the present exemplary embodiment, this mode is referred to as a temporary activation mode. As described above, according to the present exemplary embodiment, a case will be described whereby activating the image forming apparatus 101 in the temporary activation mode, the setting and execution of any job, including a print job and a scan job, are exceptionally permitted even if the license is not granted to the image forming apparatus 101.

In the temporary activation mode, for example, the setting and execution of any job, including a print job and a scan job, are permitted. From among the printing speeds changeable by the license, the lowest printing speed, e.g., 30 ppm, is specified as the printing speed in the temporary activation mode. However, the printing speed in the temporary activation mode is not limited to the above-described printing speed. A printing speed other than the lowest printing speed of the printing speeds changeable by the license can be specified as a printing speed in the temporary activation mode. Further, an operator of the vendor can be allowed to select a printing speed in the temporary activation mode. In this case, the printing speed can be selected from among the printing speeds changeable by the license.

Further, according to the present exemplary embodiment, an example will be described where the operator can activate the image forming apparatus 101 in the temporary activation mode by turning on the power of the image forming apparatus 101 while pressing a specific operation button included in the operation unit 104 with no printing speed specified.

However, if the temporary activation mode continues permanently, a user can use the image forming apparatus 101 without purchasing a license. Thus, in the present exemplary embodiment, even if the image forming apparatus 101 is activated in the temporary activation mode, the setting and execution of any job, including a print job and a scan job, are prohibited with a specific condition satisfied. As described in detail below, a condition specified based on the number of printed sheets, a condition specified based on the number of scanned sheets, and a condition specified based on the time elapsed in the temporary activation mode can be used as the specific conditions.

The above-described reboot release setting 204 is information about whether a state where the setting and execution of a job are made prohibited after the image forming apparatus 101 is activated in the temporary activation mode is cleared by the image forming apparatus 101 being rebooted. With the reboot release setting 204 ON, the setting and execution of any job, including a print job and a scan job, are made permitted again by the image forming apparatus 101 being rebooted. This allows the image forming apparatus 101 to execute printing on sheets more than the number of printable sheets by the image forming apparatus 101 being rebooted even if printing is to be executed on sheets more than the number of printable sheets to check the operation after a replacement of a component.

On the other hand, with the reboot release setting 204 OFF, once the above-described specific condition is satisfied after the image forming apparatus 101 is activated in the temporary activation mode, a state where the setting and execution of a print job and a scan job are prohibited continues even if the image forming apparatus 101 is rebooted. The above-described state continues until a license which specifies a printing speed is granted to the image forming apparatus 101.

The number of printable sheets 205 is a threshold for the number of sheets printed in the temporary activation mode. Herein, the number of sheets to be printed is not limited with the number of printable sheets 205 set to 0.

The number of scannable sheets 206 is a threshold for the number of sheets scanned in the temporary activation mode. Herein, the number of sheets scanned is not limited with the number of scannable sheets 206 set to 0.

The time limit 207 is a threshold for the time elapsed in the temporary activation mode. Herein, the time elapsed in the temporary activation mode is not limited with the time limit 207 set to 0.

In the present exemplary embodiment, the reboot release setting 204, the number of printable sheets 205, the number of scannable sheets 206, and the time limit 207 described above are previously written in the EEPROM 111 before the image forming apparatus 101 is factory-shipped. However, the present disclosure is not limited thereto. For example, the above information can be written as fixed information in a control program.

According to the present exemplary embodiment, information about the reboot release setting 204, the number of printable sheets 205, the number of scannable sheets 206, and the time limit 207 cannot be rewritten after the image forming apparatus 101 is factory-shipped.

The number of previously printed sheets 208 is used with the reboot release setting 204 OFF. The number of previously printed sheets 208 indicates the total sum of sheets printed every temporary activation mode until the previous temporary activation mode. Herein, the number of previously printed sheets 208 is updated when printing is executed in the temporary activation mode. Thus, the number of previously printed sheets 208 is updated to a value obtained by adding the total sum of the sheets printed every temporary activation mode until the previous temporary activation mode to the number of sheets printed in the current temporary activation mode (i.e., the current value). In this way, the total sum of the sheets printed in the current temporary activation mode and the sheets printed every temporary activation mode is set as the number of previously printed sheets 208. The latest value of the total sum of the sheets printed every temporary activation mode can be used as the number of printed sheets compared to the number of printable sheets 205.

The number of previously scanned sheets 209 is used with the reboot release setting 204 OFF. The number of previously scanned sheets 209 indicates the total sum of sheets scanned every temporary activation mode until the previous temporary activation mode. Herein, the number of previously scanned sheets 209 is updated when scanning is executed in the temporary activation mode. Thus, the number of previously scanned sheets 209 is updated to a value obtained by adding the total sum of the sheets scanned every temporary activation mode until the previous temporary activation mode to the number of sheets scanned in the current temporary activation mode (i.e., the current value). In this way, the total sum of the sheets scanned in the current temporary activation mode and the sheets scanned every time in the temporary activation mode is set as the number of previously scanned sheets 209. The latest value of the total sum of the sheets scanned every temporary activation mode can be used as the number of scanned sheets compared to the number of scannable sheets 206.

The previously elapsed time 210 is used with the reboot release setting 204 OFF. The previously elapsed time 210 indicates the total sum of the time that elapsed every temporary activation mode until the previous temporary activation mode. Herein, the previously elapsed time 210 is updated at regular time intervals while the temporary activation mode is being executed. Thus, the previously elapsed time 210 is updated to a value obtained by adding the total sum of the time that elapsed every temporary activation mode until the previous temporary activation mode to the time that elapsed in the current temporary activation mode (i.e., the current value). In this way, the total sum of the time that elapsed in the current temporary activation mode and the time that elapsed every temporary activation mode is set as the previously elapsed time 210. The latest value of the total sum of the time that elapsed every temporary activation mode can be used as the elapsed time compared to the time limit 207.

In the present exemplary embodiment, after the image forming apparatus 101 is activated in the temporary activation mode, the image forming apparatus 101 executes the processing for determining whether to prohibit the setting and execution of a job using the setting information illustrated in FIG. 2. An example of the control executed by the image forming apparatus 101 will be described.

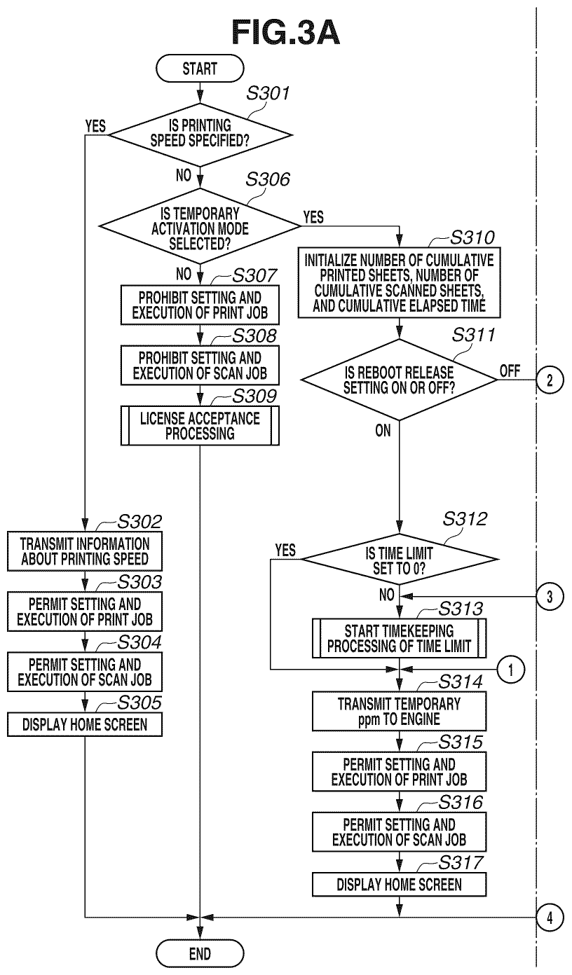

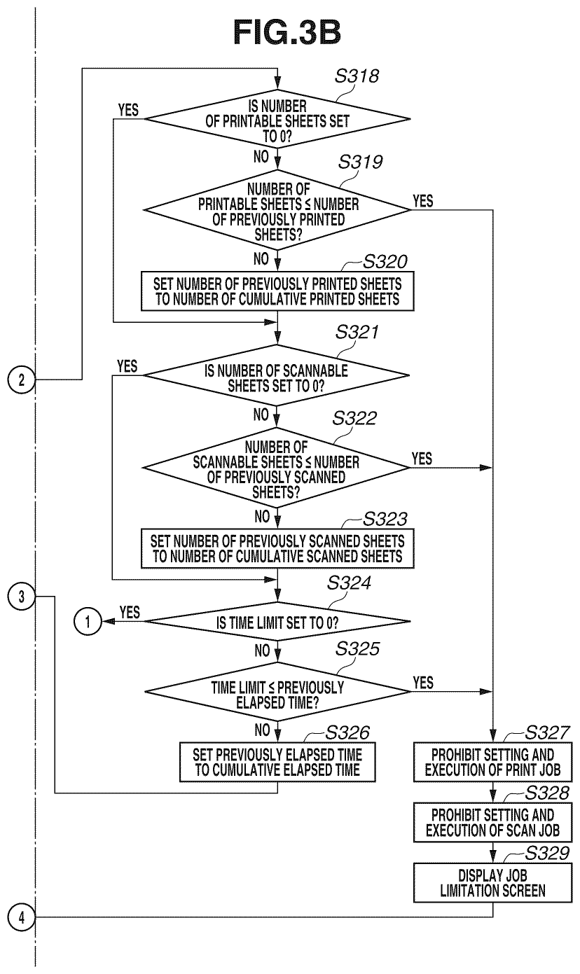

FIG. 3 is a flowchart illustrating an example of the processing executed when the image forming apparatus 101 is activated.

FIG. 3 illustrates examples of outlines of the processing executed when the printing speed is already specified by a granted license, the processing executed when the printing speed is not specified because no license is granted, and the processing executed when the temporary activation mode is selected. For example, the processing in FIG. 3 is started when the power of the image forming apparatus 101 is turned on. Further, for example, the processing illustrated in the flowchart in FIG. 3 is executed by the CPU 107 executing a control program.

First, in step S301, the CPU 107 determines whether a printing speed is specified. If the value of the printing speed 203 is not 0 ppm but 30 ppm, 40 ppm, or 50 ppm (YES in step S301), the CPU 107 determines that a printing speed is specified.

In this case, the CPU 107 executes the processing in steps S302 to S305.

In step S302, the CPU 107 notifies the printer unit 105 of the value of the printing speed 203. The printer unit 105 is notified of the printing speed and executes the operation at the printing speed notified from the CPU 107.

In step S303, the CPU 303 changes the state of the image forming apparatus 101 to a state where the setting and execution of a print job are permitted. Further, in step S304, the CPU 107 changes the state of the image forming apparatus 101 to a state where the setting and execution of a scan job are permitted. Through the processing in steps S303 and S304, the CPU 107 can set and execute a print job and a scan job.

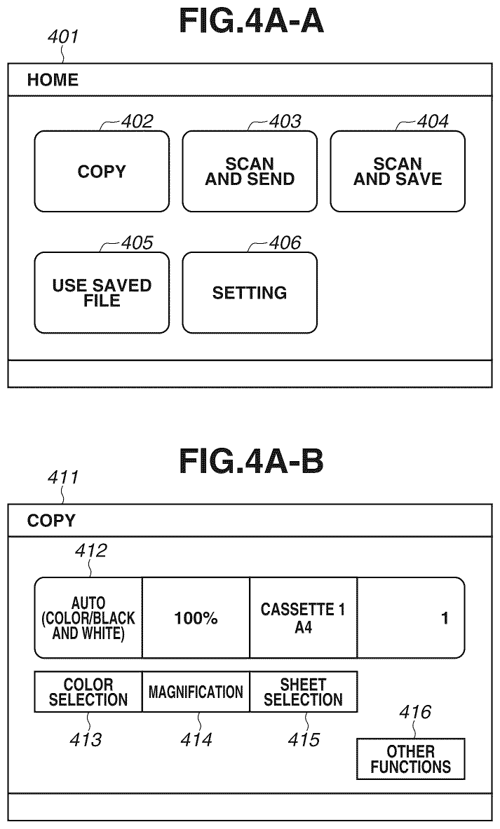

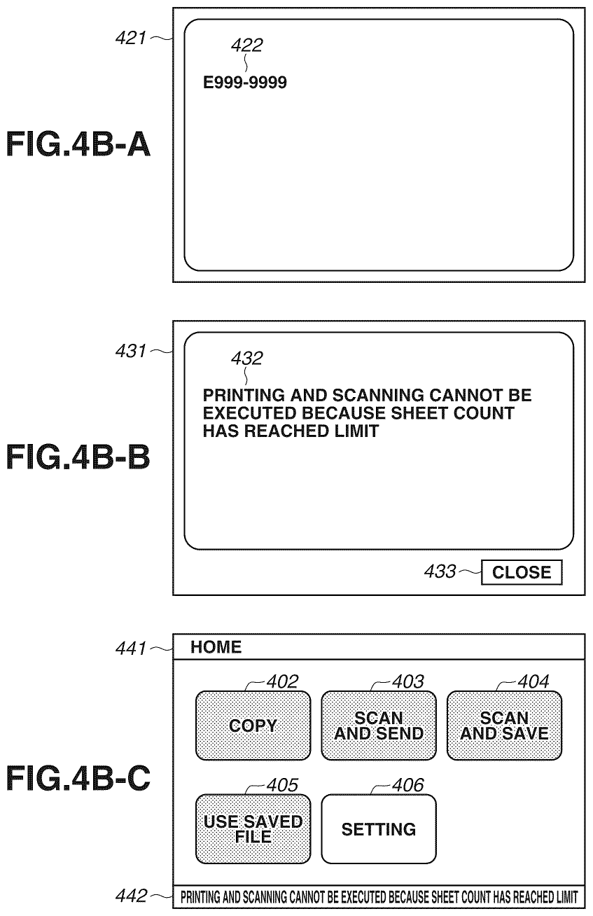

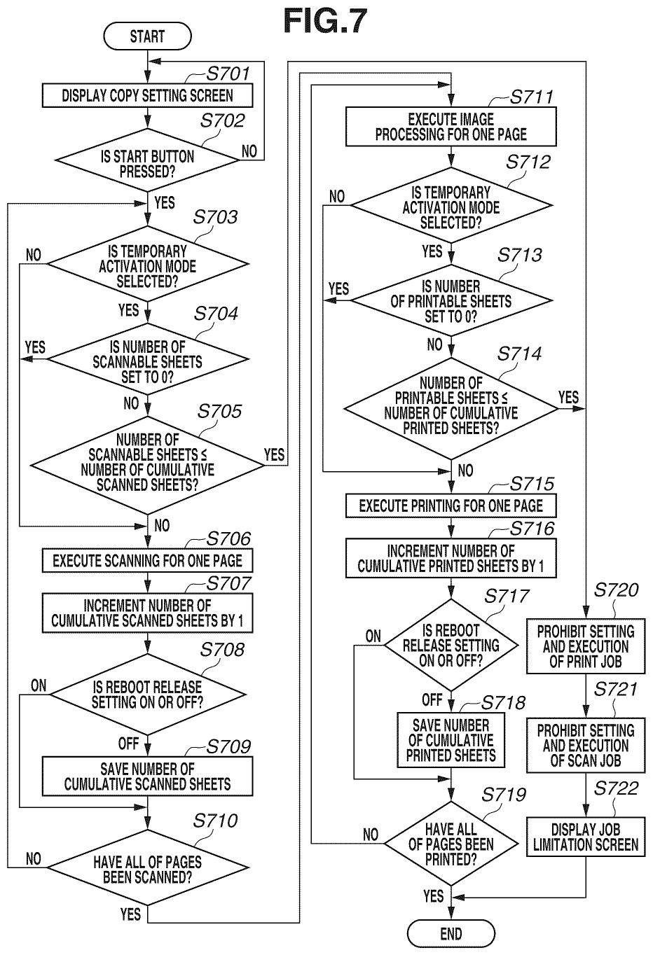

In step S305, the CPU 107 displays a home screen on the display unit 103. Then, the CPU 107 accepts operations performed by the user via the operation unit 104. An example of a home screen 401 is illustrated in FIG. 4A-A. In FIG. 4A-A, information including a copy icon 402, a scan and send icon 403, a scan and save icon 404, a use saved file icon 405, and a setting icon 406 is displayed on the home screen 401. The icons 402 to 406 are associated with the functions provided by the image forming apparatus 101. For example, when the copy icon 402 is pressed, the CPU 107 displays a copy setting screen 411 in FIG. 4A-B on the display unit 103. The CPU 107 accepts a setting for a copy job based on the operation performed on the copy setting screen 411. An example of copy job processing will be described below with reference to FIG. 7. As described above, if a printing speed of the printer unit 105 is specified, the CPU 107 can accept the settings for a print job and a scan job by executing the processing in steps S302 to S305.

An example of the processing executed by the image forming apparatus 101 when no printing speed is specified will be described.

If the printing speed 203 is 0 ppm, i.e., unspecified, in step S301 (NO in step S301), the CPU 107 executes the processing in step S306 and subsequent steps.

In step S306, the CPU 107 determines whether the image forming apparatus 101 is to be activated in the temporary activation mode. Specifically, for example, the CPU 107 determines that the image forming apparatus 101 is to be activated in the temporary mode if a specific operation button included in the operation unit 104 is pressed at the time of activation, and determines that the image forming apparatus 101 is not to be activated in the temporary mode if the specific button is not pressed at the time of activation. As the result of the determination, if the image forming apparatus 101 is not to be activated in the temporary activation mode (NO in step S306), the processing in steps S307 to S309 is executed. In step S307, the CPU 107 changes the state of the image forming apparatus 101 to a state where the setting and execution of a print job are prohibited. Then, in step S308, the CPU 107 changes the state of the image forming apparatus 101 to a state where the setting and execution of a scan job are prohibited. Through the processing in steps S307 and S308, the CPU 107 does not accept the settings for any print job or scan job, and does not execute any print job or scan job.

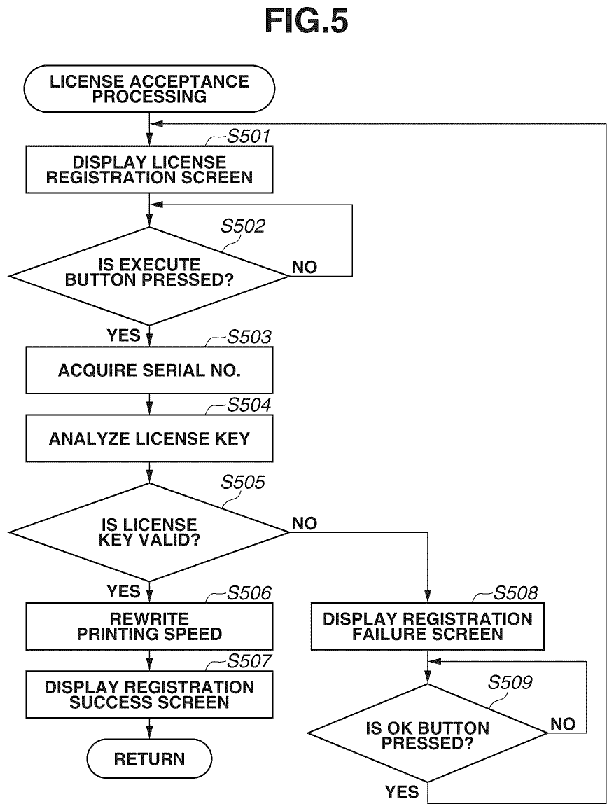

In step S309, the CPU 107 executes license acceptance processing. In the present exemplary embodiment, the CPU 107 executes the license acceptance processing to determine whether a license is to be granted to the image forming apparatus 101, and to change the printing speed when a license is granted. An example of the license acceptance processing will be described below with reference to FIG. 5.

In step S306 described above, if the CPU 107 determines that the image forming apparatus 101 is to be activated in the temporary activation mode (YES in step S306), the processing in steps S310 and subsequent steps is executed.

In step S310, the CPU 107 initializes the values of the number of cumulative printed sheets, the number of cumulative scanned sheets, and the cumulative elapsed time stored in the RAM 109 to zero (0). The number of cumulative printed sheets, the number of cumulative scanned sheets, and the cumulative elapsed time are used when the CPU 107 determines whether to limit the operation (the setting and execution of any job) executed by the image forming apparatus 101 in the temporary activation mode.

In step S311, the CPU 107 determines whether the reboot release setting 204 is ON or OFF. As the result of the determination, if the reboot release setting 204 is ON (ON in step S311), the state up to the previous state of the temporary activation mode is not considered. Thus, the CPU 107 starts executing the number counting of the cumulative printed sheets, the number counting of the cumulative scanned sheets, and the time counting of the cumulative elapsed time from zero (0).

In this case, in step S312, the CPU 107 determines whether the value of the time limit 207 is zero (0). As the result of the determination, if the value of the time limit 207 is zero (0), i.e., no time limit is specified, (YES in step S312), the CPU 107 executes the processing in step S314 without executing the timekeeping processing of the time limit in step S313.

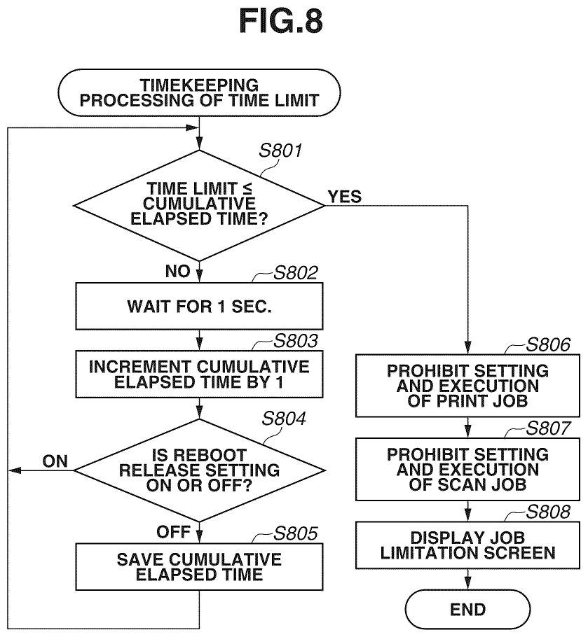

On the other hand, as the result of the determination in step S312, if the value of the time limit 207 is other than zero (0) (NO in step S312), the processing in step S313 is executed. In step S313, the CPU 107 starts executing the timekeeping processing of the time limit. In the timekeeping processing of the time limit, the CPU 107 executes the time counting of time that elapsed in the temporary execution mode and the processing for determining whether to prohibit the operation (the setting and execution of any job) executed by the image forming apparatus 101. An example of the timekeeping processing of the time limit will be specifically described below with reference to FIG. 8. Further, herein, the CPU 107 starts executing the below-described processing in step S314 when the timekeeping processing of the time limit is started. In other words, herein, the processing illustrated in the flowchart in FIG. 8 described below is executed in concurrence with the processing illustrated in the flowchart in FIG. 3, and the processing in step S314 is executed before the processing illustrated in the flowchart in FIG. 8 is ended.

In step S314, the CPU 107 notifies the printer unit 105 of a temporary ppm. In the present exemplary embodiment, the lowest printing speed, 30 ppm, is used as the temporary ppm, from among the printing speeds 30 ppm, 40 ppm, and 50 ppm. Further, in the present exemplary embodiment, the CPU 107 notifies the printer unit 105 of the temporary ppm. However, the present disclosure is not limited thereto. For example, the CPU 107 can notify the printer unit 105 that the temporary activation mode is selected, so that the printer unit 105 determines the printing speed based on the received notification. The example of the processing in steps S315 to S317 is similar to the above-described processing in steps S303 to S305, so that detailed descriptions of the processing in steps S315 to S317 are omitted.

An example of the processing executed by the image forming apparatus 101 with the reboot release setting 204 OFF will be described.

The processing executed with the reboot release setting 204 OFF is different from the processing executed with the reboot release setting 204 ON in that the state up to the previous state of the temporary activation mode is taken into consideration. An example of the difference will be described in step S318 and subsequent steps.

First, in step S318, the CPU 107 determines whether the value of the number of printable sheets 205 is zero (0). As the result of the determination, if the value of the number of printable sheets 205 is zero (0), i.e., the number of printable sheets is not specified, (YES in step S318), the CPU 107 executes the below-described processing in step S321 without executing the processing in steps S319 and S320.

On the other hand, as the result of the determination in step S318, if the value of the number of printable sheets 205 is other than zero (0) (NO in step S318), the CPU 107 executes the processing in step S319. In step S319, the CPU 107 determines whether the value of the number of previously printed sheets 208 is greater than or equal to the value of the number of printable sheets 205. As the result of the determination, if the value of the number of previously printed sheets 208 is greater than or equal to the value of the number of printable sheets 205, the cumulative value of the number of sheets printed in the temporary activation mode has reached the upper limit.

In the present exemplary embodiment, the number of sheets printed in the temporary activation mode is cumulated when the temporary activation mode is repeated at time intervals. The same can also go for the number of scanned sheets and the elapsed time described below in steps S321 to S326. In the below described exemplary embodiment, a state where the value of the number of previously printed sheets 208, the value of the number of previously scanned sheets 209, and the value of the previously elapsed time 210 have respectively reached the value of the number of printable sheets 205, the value of the number of scannable sheets 206, and the value of the time limit 207 is expressed as “a value has reached a limit”, as appropriate.

As the result of the determination in step S319, if the value of the number of previously printed sheets 208 is greater than or equal to the value of the number of printable sheets 205 (YES in step S319), the processing in steps S327 to S329 is executed. In step S327, the CPU 107 changes the state of the image forming apparatus 101 to a state where the setting and execution of a print job is prohibited. Then, in step S328, the CPU 107 changes the state of the image forming apparatus 101 to a state where the setting and execution of a scan job is prohibited. Through the processing in steps S327 and S328, the CPU 107 does not accept the settings for any print job or scan job, and does not execute any print job or scan job.

Then, in step S329, the CPU 107 displays a job limitation screen on the display unit 103. Information indicating that the setting and execution of a print job and a scan job are prohibited is displayed on the job limitation screen.

FIGS. 4B-A, 4B-B, and 4B-C are diagrams illustrating examples of job limitation screens 421, 431, and 441, respectively.

In the job limitation screen 421 illustrated in FIG. 4B-A, an error code indicating that a value has reached the limit is displayed on an error code display portion 422. In the job limitation screen 431 illustrated in FIG. 4B-B, a message indicating that a value has reached the limit is displayed on a message display portion 432. Further, as illustrated in FIG. 4B-B, a close button 433 can be provided on the job limitation screen 431. In this case, the CPU 107 turns off the job limitation screen 431 when the Close button 433 is pressed by a user who has checked the message.

Thus, the user can change the setting not related to the print job and the scan job. In the job limitation screen 441 illustrated in FIG. 4B-C, a message indicating that a value has reached the limit is displayed on a status display portion 442 of the home screen 401. At this time, the CPU 107 can display an icon related to the print job and the scan job in a non-selectable state. In FIG. 4B-C, a copy icon 402, a scan and send icon 403, a scan and save icon 404, and a use saved file icon 405 are displayed in a non-selectable state. The CPU 107 can also display a setting icon 406 in a non-selectable state.

Referring back to the flowchart in FIG. 3, the processing in step S319 will be described. As the result of the determination in step S319, if the value of the number of previously printed sheets 208 is less than the value of the number of printable sheets 205 (NO in step S319), the processing in S320 is executed. In step S320, the CPU 107 sets the value of the number of previously printed sheets 208 to the number of cumulative printed sheets stored in a storage area secured in the RAM 109. Through the above processing, the number of cumulative printed sheets can be taken over to the current temporary activation mode from the previous temporary activation mode.

In step S321, the CPU 107 determines whether the value of the number of scannable sheets 206 is zero (0). As the result of the determination, if the value of the number of scannable sheets 206 is zero (0), i.e., the number of scannable sheets is not specified, (YES in step S321), the CPU 107 executes the below-described processing in step S324 without executing the processing in steps S322 to S323.

On the other hand, as the result of the determination in step S321, if the value of the number of scannable sheets 206 is other than zero (0) (NO in step S321), the processing in step S322 is executed. In step S322, the CPU 107 determines whether the value of the number of previously scanned sheets 209 is greater than or equal to the value of the number of scannable sheets 206. As the result of the determination, if the value of the number of previously scanned sheets 209 is greater than or equal to the value of the number of scannable sheets 206 (YES in step S322), the cumulative value of the number of sheets scanned in the temporary activation mode has reached the upper limit. Thus, similarly to the case where the value of the number of previously printed sheets 208 is greater than or equal to the value of the number of printable sheets 205, the CPU 107 executes the processing in steps S327 to S329 to prohibit the setting and execution of a print job and a scan job. Thereafter, the CPU 107 displays the job limitation screen on the display unit 103.

On the other hand, as the result of the determination in step S322, if the value of the number of previously scanned sheets 209 is less than the value of the number of scannable sheets 206 (NO in step S322), the processing in step S323 is executed. In step S323, the CPU 107 sets the value of the number of previously scanned sheets 209 to the number of cumulative scanned sheets stored in the storage area secured in the RAM 109. Through the above processing, the number of cumulative scanned sheets can be taken over to the current temporary activation mode from the previous temporary activation mode.

In step S324, the CPU 107 determines whether the value of the time limit is zero (0). As the result of the determination, if the value of the time limit 207 is zero (0), i.e., the time limit is not specified (YES in step S324), the above-described processing in step S314 is executed.

On the other hand, as the result of the determination in step S324, if the value of the time limit 207 is other than zero (0) (NO in step S324), the processing in step S325 is executed. In step S325, the CPU 107 determines whether the value of the previously elapsed time 210 is greater than or equal to the value of the time limit 207. As the result of the determination, if the value of the previously elapsed time 210 is greater than or equal to the value of the time limit 207 (YES in step S325), the cumulative value of time that elapsed in the temporary activation mode has reached the upper limit. Thus, similarly to the case where the value of the number of previously printed sheets 208 is greater than or equal to the value of the number of printable sheets 205, the CPU 107 executes the processing in steps S327 to S329 to prohibit the setting and execution of a print job and a scan job. Thereafter, the CPU 107 displays the job limitation screen on the display unit 103.

On the other hand, as the result of the determination in step S325, if the value of the previously elapsed time 210 is less than the value of the time limit 207 (NO in step S325), the processing in step S326 is executed. In step S326, the CPU 107 sets the value of the previously elapsed time 210 to the cumulative elapsed time stored in the storage area secured in the RAM 109. Through the above processing, the cumulative elapsed time can be taken over to the current temporary activation mode from the previous temporary activation mode. When the processing in step S326 is ended, the above-described processing in step S313 is executed. The processing in the subsequent steps is similar to the processing in steps S313 to S317 executed when the reboot release setting 204 is determined to be ON in step S311. Thus, the detailed descriptions of the processing in steps S313 to S317 executed when the reboot release setting 204 is determined to be OFF in step S311 are omitted.

The pieces of processing respectively executed by the image forming apparatus 101 when a printing speed is already specified, when a printing speed is not specified because no license is granted, and when the temporary activation mode is selected, are described as the above.

An example of the license acceptance processing in step S309 will be described in detail with reference to FIG. 5.

The processing illustrated in the flowchart in FIG. 5 is executed by the CPU 107 executing a control program.

First, in step S501, the CPU 107 displays a license registration screen on the display unit 103.

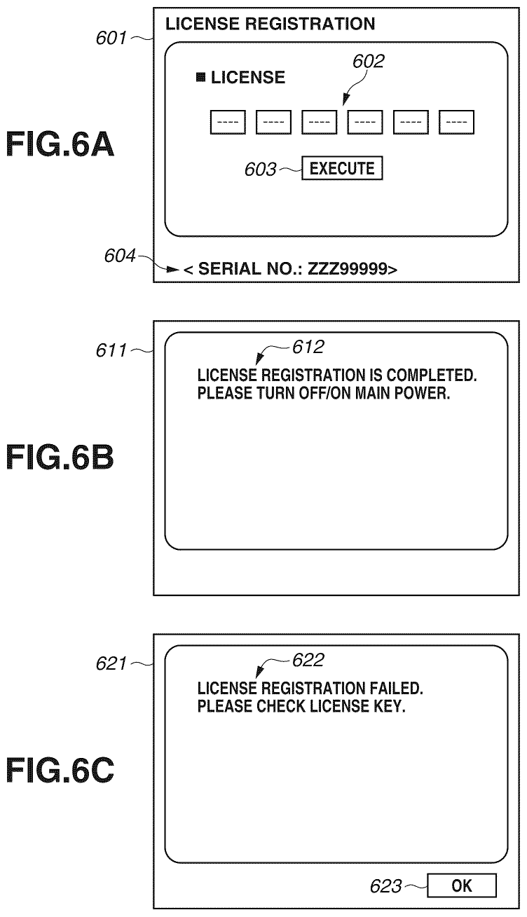

FIG. 6A is a diagram illustrating an example of a license registration screen 601. In FIG. 6A, information including a license key input portion 602, an execute button 603, and a serial No. display portion 604 is displayed on the license registration screen 601.

A license key is associated with the serial No. 202 of the image forming apparatus 101. In FIG. 6A, in order to allow the user to check and input a license key, the value of the serial No. 202 of the image forming apparatus 101 is displayed on a display portion 604.

The user inputs a license key (e.g., a figure in predetermined digits) to the license key input portion 602 to press the execute button 603 via the operation unit 104. In step S502, the CPU 107 waits until the execute button 603 is pressed. If the execute button 603 is pressed (YES in step S502), the processing in step S503 is executed. In step S503, the CPU 107 acquires the value of the serial No. 202.

Next, in step S504, the CPU 107 analyzes the license key based on the license key input to the license key input portion 602 and the value of the serial No. 202 acquired in step S503. For example, the CPU 107 executes an analysis to determine whether the license key input to the license key input portion 602 is a valid license key, and to specify a value (ppm) of the printing speed of the image forming apparatus 101.

In step S505, based on the result of the analysis in step S504, the CPU 107 determines whether the license key input to the license key input portion 602 is a valid license key. As the result of the determination, if the license key input to the license key input portion 602 is a valid license key (YES in step S505), the processing in step S506 is executed. In step S506, the CPU 107 rewrites the value of the printing speed 203 to a printing speed specified based on the result of the analysis in step S503.

The CPU 107 determines the validity of the license key by determining whether the license key input to the license key input portion 602 matches the license key associated with the value of the serial No. 202 acquired in step S503. Further, the validity of the license key can be determined by an external device. In this case, for example, the image forming apparatus 101 can transmit the information about the license key input to the license key input portion 602 to the external device. Then, the external device can determine whether the information about the license key is valid license key information, and transmit the determination result to the image forming apparatus 101.

In step S507, the CPU 107 displays a registration success screen 611 illustrated in FIG. 6B on the display unit 103. In the registration success screen 611 in FIG. 6B, a message indicating the success in license registration and a message prompting the user to reboot the image forming apparatus 101 are displayed on the message display portion 612. In the present exemplary embodiment, when the image forming apparatus 101 is rebooted after the registration success screen 611 is displayed, the image forming apparatus 101 can execute printing at the printing speed rewritten in step S503.

On the other hand, in step S505, if the CPU 107 determines that the license key input to the license key input portion 602 is not a valid license key (invalid license key) (NO in step S505), the processing in step S508 is executed. In step S508, the CPU 107 displays a registration failure screen 621 illustrated in FIG. 6C on the display unit 103. In the registration failure screen 621 in FIG. 6C, a message indicating the failure in license registration and a message prompting the user to check the license key are displayed on the message display portion 622. Further, in the registration failure screen 621 in FIG. 6C, an OK button 623 is also displayed. In step S509, the CPU 107 waits until the OK button 623 is pressed. If the OK button 623 is pressed (YES in step S509), the processing in step S501 is executed again. As described above, in step S501, the CPU 107 displays the license registration screen 601 illustrated in FIG. 6A on the display unit 103.

The example of the processing for changing the printing speed by granting a license has been described as described above.

An example of the processing executed by the image forming apparatus 101 when a job control is executed based on the number of printed sheets and the number of scanned sheets will be described with reference to a flowchart in FIG. 7. Herein, a copy job is described as an example of the job. In the copy job, processing including printing and scanning is executed. For example, the processing illustrated in the flowchart in FIG. 7 is started when the copy icon 402 displayed on the home screen 401 is pressed. Further, the processing illustrated in the flowchart in FIG. 7 is executed by the CPU 107 executing a control program.

In step S701, the CPU 107 displays a copy setting screen 411 illustrated in FIG. 4A-B on the display unit 103. In FIG. 4A-B, a setting display portion 412, a Color selection setting button 413, a magnification setting button 414, a sheet selection setting button 415, and another functions button 416 are displayed on the copy setting screen 411.

On the copy setting screen 411, contents of the current settings related to a copy job are displayed. The user can change the contents of the settings related to the copy job by operating the color selection setting button 413, the magnification setting button 414, the sheet selection setting button 415, and the other functions button 416. Setting contents input via these buttons are not limited as long as the settings are related to the copy function.

Referring back to the flowchart in FIG. 7, the processing in step S702 is described. In step S702, the CPU 107 accepts the setting of the copy function until a start button is pressed through the operation unit 104. When the start button is pressed (YES in step S702), the processing in step S703 is executed. In step S703, the CPU 107 determines whether the image forming apparatus 101 is activated in the temporary activation mode. As the result of the determination, if the image forming apparatus 101 is not activated in the temporary activation mode (NO in step S703), the CPU 107 does not limit the number of scannable sheets. In this case, the CPU 107 executes the below-described processing in step S706 without executing the processing in steps S704 and S705. On the other hand, as the result of the determination in step S703, if the image forming apparatus 101 is activated in the temporary activation mode (YES in step S703), the processing in step S704 is executed.

In step S704, the CPU 107 determines whether to limit the number of scannable sheets. Specifically, for example, the CPU 107 determines whether the value of the number of scannable sheets 206 is zero (0). As the result of the determination, if the value of the number of scannable sheets is zero (0), i.e., the number of scannable sheets is not specified (YES in step S704), the CPU 107 executes the below-described processing in step S706 without executing the processing in step S705. On the other hand, if the value of the number of scannable sheets 206 is other than zero (0) (NO in step S704), the processing in step S705 is executed.

In step S705, the CPU 107 determines whether the value of the number of cumulative scanned sheets is greater than or equal to the value of the number of scannable sheets 206. As the result of the determination, if the value of the number of cumulative scanned sheets is greater than or equal to the value of the number of scannable sheets 206 (YES in step S705), the number of sheets scanned in the temporary activation mode has reached the upper limit at that point in time. In step S720, the CPU 107 changes the state of the image forming apparatus 101 to a state where the setting and execution of a print job are prohibited. Then, in step S721, the CPU 107 changes the state of the image forming apparatus 101 to a state where the setting and execution of a scan job are prohibited. Through the processing in steps S720 and S721, the CPU 107 cancels a print job and scan job in current execution and the subsequent jobs. Then, the CPU 107 does not accept the settings for subsequent jobs and does not execute the subsequent jobs.

In step S722, the CPU 107 displays a job limitation screen on the display unit 103. An example of the processing in step S722 is similar to the above-described processing in step S329, so that the detailed descriptions of the processing in step S722 are omitted.

In step S705, if the CPU 107 determines that the value of the number of cumulative scanned sheets is less than the value of the number of scannable sheets 206 (NO in step S705), the processing in step S706 is executed. In step S706, the CPU 107 instructs the scanner unit 106 to execute scanning one page.

In step S707, the CPU 107 increments the number of cumulative scanned sheets by 1 (sheet).

In step S708, the CPU 107 determines whether the reboot release setting 204 is ON or OFF. As the result of the determination, if the reboot release setting 204 is ON (ON in step S708), the CPU 107 executes the below-described processing in step S710 without executing the processing in step S709.

On the other hand, as the result of the determination in step S708, if the reboot release setting 204 is OFF (OFF in step S708), the processing in step S709 is executed. In step S709, the CPU 107 rewrites the value of the number of previously scanned sheets 209 to the value of the number of cumulative scanned sheets. Through the above processing, the value of the number of cumulative scanned sheets can be taken over to the temporary activation mode after the reboot.

In step S710, the CPU 107 determines whether the scanning of all of the pages specified by the copy job is completed. As the result of the determination, if the scanning of all of the pages is not completed (NO in step S710), the above-described processing in step S703 is executed again. The processing in steps S703 to S710 is executed repeatedly until the scanning of all of the pages is completed.

As the result of the determination in step S710, if the scanning of all of the pages is completed (YES in step S710), the processing in step S711 is executed. In step S711, the CPU 107 executes image processing on the pages to be printed, according to the settings for the copy job.

In step S712, the CPU 107 determines whether the image forming apparatus 101 is activated in the temporary activation mode. As the result of the determination, if the image forming apparatus 101 is not activated in the temporary activation mode (NO in step S712), the CPU 107 does not limit the number of printable sheets. In this case, the CPU 107 executes the below-described processing in step S715 without executing the processing in steps S713 and S714.

On the other hand, as the result of the determination in step S712, if the image forming apparatus 101 is activated in the temporary activation mode (YES in step S712), the processing in step S713 is executed. In step S713, the CPU 107 determines whether to limit the number of printable sheets. Specifically, for example, the CPU 107 determines whether the value of the number of printable sheets 205 is zero (0). As the result of the determination, if the value of the number of printable sheets is zero (0), i.e., the number of printable sheets is not specified (YES in step S713), the CPU 107 executes the below-described processing in step S715 without executing the processing in step S714. On the other hand, if the value of the number of printable sheets 205 is other than zero (0) (NO in step S713), the processing in step S714 is executed.

In step S714, the CPU 107 determines whether the value of the number of cumulative printable sheets is greater than or equal to the value of the number of printable sheets 205. As the result of the determination, if the value of the number of cumulative printed sheets is greater than or equal to the value of the number of printable sheets 205 (YES in step S714), the number of sheets printed in the temporary activation mode has reached the upper limit at that point in time. Thus, the above-described processing in steps S720 to S722 is executed. Through the processing in steps S720 and S721, the CPU 107 cancels a print job and a scan job in current execution and the subsequent job.

Then, the CPU 107 does not accept the settings for subsequent jobs and does not execute the subsequent jobs.

On the other hand, in step S714, if the value of the number of cumulative printed sheets is less than the value of the number of printable sheets 205 (NO in step S714), the processing in step S715 is executed. In step S715, the CPU 107 instructs the printer unit 105 to execute printing one page.

In step S716, the CPU 107 increments the number of cumulative printed sheets by 1 (sheet).

In step S717, the CPU 107 determines whether the reboot release setting 204 is ON or OFF. As the result of the determination, if the reboot release setting 204 is ON (ON in step S717), the CPU 107 executes the processing in step S719 without executing the processing in step S718.

On the other hand, as the result of the determination in step S717, if the reboot release setting 204 is OFF (OFF in step S717), the processing in step S718 is executed. In step S718, the CPU 107 rewrites the value of the number of previously printed sheets 208 to the value of the number of cumulative printed sheets. Through the above processing, the value of the number of cumulative printed sheets can be taken over to the temporary activation mode after the reboot.

In step S719, the CPU 107 determines whether printing of all of the pages specified by the copy job is completed. As the result of the determination, if the printing of all of the pages is not completed (NO in step S719), the above-described processing in step S711 is executed again. The processing in steps S711 to S719 is executed repeatedly until the printing of all of the pages is completed.

As the result of determination in step S719, if the printing of all of the pages is completed (YES in step S719), the CPU 107 ends the processing illustrated in the flowchart in FIG. 7.

The example of the processing for controlling a copy job based on the number of printed sheets and the number of scanned sheets has been described as descried above.

Lastly, an example of the processing executed by the image forming apparatus 101, when a job is limited based on the time that elapsed in the temporary activation mode, will be described with reference to a flowchart in FIG. 8. As described above, an instruction to start the processing illustrated in the flowchart in FIG. 8 is issued through the processing in step S313 of FIG. 3. Further, the processing illustrated in the flowchart in FIG. 8 is executed by the CPU 107 executing a control program.

In step S801, the CPU 107 determines whether the value of the cumulative elapsed time is greater than or equal to the value of the time limit 207. As the result of the determination, if the value of the cumulative elapsed time is greater than or equal to the value of the time limit 207 (YES in step S801), the time that elapsed in the temporary activation mode has reached the upper limit at that point in time. Thus, the processing in steps S806 to S808 is executed. The example of the processing in steps S806 to S808 is similar to the above-described processing in steps S720 to S722, so that the detailed descriptions of the processing in steps S806 to S808 are omitted. Through the processing in steps S806 and S807, the CPU 107 cancels a print job and a scan job in current execution and subsequent jobs. Then, the CPU 107 does not accept the settings for subsequent jobs, and does not execute the subsequent jobs.

In step S801, if the CPU 107 determines that the value of the cumulative elapsed time is less than the value of the time limit 207 (NO in step S801), the processing in steps S802 and S803 is executed. In step S802, the CPU 107 waits for 1 sec. Then, in step S803, the CPU 107 increments the value of the cumulative elapsed time by 1 (sec.).

In step S804, the CPU 107 determines whether the reboot release setting 204 is ON or OFF. As the result of the determination, if the reboot release setting 204 is ON (ON in step S804), the CPU 107 executes the above-described processing in step S801 again without executing the processing in step S805.

On the other hand, if the reboot release setting 204 is OFF (OFF in step S804), the processing in step S805 is executed. In step S805, the CPU 107 rewrites the value of the previously elapsed time 210 to the value of the cumulative elapsed time. Through the above processing, the value of the cumulative elapsed time can be taken over to the temporary activation mode after the reboot.

The example of the processing for limiting a job based on the time that elapsed in the temporary activation mode has been described as described above.

As described above, according to the present exemplary embodiment, the setting and execution of a job are exceptionally permitted on the image forming apparatus 101 when a license is not granted, and prohibited when the setting and execution of a job are exceptionally permitted on the image forming apparatus 101. This prevents the image forming apparatus 101 from performing an operation that does not square with reality after the factory shipment. For example, this makes it possible to allow an operator of the vendor to exceptionally use a function, such as a printing function, even if a license is not granted, and also to reduce the risk that a function, such as a printing function, is used by a user without a granted license. Consequently, for example, a function provided by the image forming apparatus 101, such as a printing function, the function of which is enabled by a granted license, can be prevented from being used permanently without the license.

According to the present exemplary embodiment, the case has been described where the number of printable sheets 205, the number of scannable sheets 206, and the time limit 207 are not changed from values set at the time of factory shipment. However, the present disclosure is not limited thereto. For example, with the reboot release setting 204 ON, the CPU 107 can automatically reduce (or shorten) the values of the number of printable sheets 205, the number of scannable sheets 206, and the time limit 207 to values within a range exceeding zero (0), depending on the number of executions of the temporary activation mode. Thus, frequent reboots of the image forming apparatus 101 in the temporary activation mode makes it easy to prohibit the setting and execution of a job. Consequently, the risk that a function, such as a printing function, is used by a user without a license can be further reduced.

Further, in the present exemplary embodiment, the case has been described of a license for specifying a printing speed as a license for permitting the execution of a job, including a print job. However, the license is not limited to the above-described license. For example, a parameter for executing a job can be a parameter other than a printing speed, e.g., a parameter related to image quality.

Further, the license can be a license for permitting the execution of all of the functions provided by the image forming apparatus 101. In this case, for example, the execution of all of the functions provided by the image forming apparatus 101 can be prohibited if the value of the elapsed time (e.g., cumulative elapsed time) in the temporary execution mode is greater than or equal to the value of the time limit 207 when the image forming apparatus 101 is operating in the temporary activation mode.

Furthermore, for example, the license can be a license for permitting the execution of an optional function (e.g., stapling and punching functions) provided by the image forming apparatus 101. In this case, for example, the setting and execution of stapling can be prohibited if at least one of the cumulative value of the number of times of stapling executed in the temporary activation mode and the cumulative value of the number of staples used in the temporary activation mode is greater than or equal to a limit value when the image forming apparatus 101 is operating in the temporary activation mode. Further, for example, setting and execution of punching may be prohibited in a case where a cumulative value of the number of times of punching executed in the temporary activation mode has become greater than or equal to a limit value when the image forming apparatus 101 is operating in the temporary activation mode. Furthermore, the setting and execution of at least one of stapling and punching can be prohibited if the value of the elapsed time (e.g., cumulative elapsed time) in the temporary activation mode is greater than or equal to the value of the time limit 207.

### Other Exemplary Embodiments

The present disclosure can be realized through the processing in which a program for executing one or more functions according to the above-described exemplary embodiments is supplied to a system or an apparatus via a network or a storage medium, and one or more processors in the system or the apparatus read and execute the program. Further, the present disclosure can also be realized with a circuit (e.g., application specific integrated circuit (ASIC)) which implements one or more functions.

The above-described exemplary embodiments are merely examples embodying the present disclosure, and shall not be construed as limiting the technical scope of the present disclosure. In other words, the present disclosure can be realized in diverse ways without departing from the technical spirit or main features of the present disclosure.

For example, the disclosure of the present exemplary embodiments includes configurations, a method, and a program as follows: (Configuration 1)

An image forming apparatus comprising;
an execution unit configured to execute a function of the image forming apparatus;
an acceptance unit configured to accept an operation; and
a control unit configured to execute control to permit the execution of the function with a license which permits the execution of the function granted, and to prohibit the execution of the function with the license not granted,
wherein the control unit exceptionally permits the execution of the function based on the acceptance of a predetermined operation by the acceptance unit even with the license not granted, and prohibits the execution of the function based on a satisfaction of a condition with the execution of the function exceptionally permitted.

### Configuration 2

The image forming apparatus according to configuration 1, wherein the function includes a function for executing a job including printing.

### Configuration 3

The image forming apparatus according to configuration 1, wherein the license includes a license which specifies a parameter for executing a job.

### Configuration 4

The image forming apparatus according to configuration 3, wherein the parameter specification includes a specification related to an image forming speed.

### Configuration 5

The image forming apparatus according to configuration 1, wherein the control unit prohibits the execution of the function with a power to execute the function being supplied.

### Configuration 6

The image forming apparatus according to configuration 1, wherein, with a release condition satisfied, the control unit releases the image forming apparatus from a state where the execution of the function is prohibited based on the satisfaction of the release condition.

### Configuration 7

The image forming apparatus according to configuration 6, wherein the release condition includes a reboot of the image forming apparatus.

### Configuration 8

The image forming apparatus according to configuration 6, wherein the release condition includes a grant of the license.

### Configuration 9

The image forming apparatus according to configuration 1, wherein the condition includes a condition based on an operation executed by the image forming apparatus with the execution of the function exceptionally permitted.

### Configuration 10

The image forming apparatus according to configuration 9, wherein the operation includes a number counting executed depending on an execution of a job with the execution of the function exceptionally permitted, and a period during which the execution of the function is exceptionally permitted.

### Method 1

A control method for an image forming apparatus, the control method comprising:
executing a function of the image forming apparatus;
accepting an operation; and
executing control to permit the execution of the function with a license which permits the execution of the function granted, and to prohibit the execution of the function with the license not granted,
wherein, through the control, the execution of the function is exceptionally permitted based on the acceptance of a predetermined operation even with the license not granted, and the execution of the function is prohibited based on a satisfaction of a condition with the execution of the function exceptionally permitted.

### Medium 1

A non-transitory computer readable storage medium that stores a program for causing an image forming apparatus to execute a control method for the image forming apparatus, the control method comprising:
executing a function of the image forming apparatus;
accepting an operation; and
executing control to permit the execution of the function with a license which permits the execution of the function granted, and to prohibit the execution of the function with the license not granted,
wherein, through the control, the execution of the function is exceptionally permitted based on the acceptance of a predetermined operation even with the license not granted, and the execution of the function is prohibited based on a satisfaction of a condition with the execution of the function exceptionally permitted.

According to the present invention, the image forming apparatus is enabled to efficiently operate in an actual situation following factory shipment.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-142175, filed Sep. 1, 2023, which is hereby incorporated by reference herein in its entirety.

What is claimed is:

1. An image forming apparatus comprising:
one or more memories; and
one or more processors executing instructions stored in the one or more memories to:
execute a function of the image forming apparatus;
accept an operation; and
control to permit the execution of the function with a license granting permission to execute the function and to prohibit the execution of the function when the license is not granted,
wherein the execution of the function is exceptionally permitted based on acceptance of a predetermined operation even when the license is not granted, and
wherein the execution of the function is prohibited based on a satisfaction of a condition with the execution of the function exceptionally permitted.

2. The image forming apparatus according to claim 1, wherein the function includes a function for executing a job including printing.

3. The image forming apparatus according to claim 1, wherein the license includes a license specifying a parameter for executing a job.

4. The image forming apparatus according to claim 3, wherein a specification of the parameter includes a specification related to an image forming speed.

5. The image forming apparatus according to claim 1, wherein the execution of the function is prohibited in a state where a power to execute the function is supplied.

6. The image forming apparatus according to claim 1, wherein, with a release condition satisfied, the image forming apparatus released from a state where the execution of the function is prohibited based on the satisfaction of the release condition.

7. The image forming apparatus according to claim 6, wherein the release condition includes a reboot of the image forming apparatus.

8. The image forming apparatus according to claim 6, wherein the release condition includes a grant of the license.

9. The image forming apparatus according to claim 1, wherein the condition includes a condition based on an operation executed by the image forming apparatus with the execution of the function exceptionally permitted.

10. The image forming apparatus according to claim 9, wherein the operation includes a number counting which is executed depending on an execution of a job with the execution of the function exceptionally permitted and a period during that the execution of the function is exceptionally permitted.

11. A control method for an image forming apparatus comprising:
executing a function of the image forming apparatus;
accepting an operation; and
executing control to permit the execution of the function with a license granting permission to execute the function and to prohibit the execution of the function when the license is not granted,
wherein, through the control, the execution of the function is exceptionally permitted based on acceptance of a predetermined operation even when the license is not granted and the execution of the function is prohibited based on a satisfaction of a condition with the execution of the function exceptionally permitted.

12. A non-transitory computer readable storage medium that stores a program for causing an image forming apparatus to execute a control method for the image forming apparatus, the control method comprising:
executing a function of the image forming apparatus;
accepting an operation; and
executing control to permit the execution of the function with a license granting permission to execute the function and to prohibit the execution of the function when the license is not granted,
wherein, through the control, the execution of the function is exceptionally permitted based on acceptance of a predetermined operation even when the license is not granted and the execution of the function is prohibited based on a satisfaction of a condition with the execution of the function exceptionally permitted.
